(19) United States
(12) Patent Application Publication
(10) Pub. No.: US 2014/0075315 A1
(43) Pub. Date: Mar. 13, 2014

(54) MEDIA REPRODUCTION CONTROL ARRANGEMENT AND METHOD

(71) Applicant: David Karlsson, Lund (SE)

(72) Inventor: David Karlsson, Lund (SE)

(73) Assignee: SONY MOBILE COMMUNICATIONS AB, Lund (SE)

(21) Appl. No.: 13/976,203

(22) PCT Filed: Sep. 28, 2012
(86) PCT No.: PCT/EP2012/069229

§ 371 Date: Jun. 26, 2013

Related U.S. Application Data
(60) Provisional application No. 61/552,086, filed on Oct. 27, 2011.

(51) Int. Cl. G06F 3/0484

(52) U.S. Cl. CPC G06F 3/0484
USPC 715/716

(57) ABSTRACT

The invention relates to a method and arrangement for rescaling a time line (163) corresponding to reproduction of a media on an electrical device (100). The device comprises a touch sensitive screen (160). In a first operative mode a time line control signal is generated during the reproduction of the media on the touch sensitive screen in a first scale. The method comprising: setting a second mode by displacing a pointing means whereby, said displacement of said pointing means is responsive of changing of said time line scale.

### TECHNICAL FIELD

The present invention relates to a method and arrangement for enhancing precision media reproduction in general and precision of replay of a media reproduced on an electrical device having a touch-screen in particular.

### BACKGROUND

Hand held devices, such as mobile phones, digital cameras, and pocket computers etc., with graphical user interfaces have become increasingly popular in recent years. The most common example of a pocket computer is a smart phone, which may be embodied in various different forms.

Commonly hand held devices are also provided with play functionality for playing recorded video and audio.

The graphical display is typically touch-sensitive and may be operated by way of a pointing tool such as a stylus, pen or a user's finger, Other devices rely more on a touch-sensitive display as the main input device and may thus have dispensed with a hardware keyboard.

The hand held device used as mobile terminals, i.e. in addition to providing typical pocket computer services such as calendar, word processing and games, they may also be used in conjunction with a mobile telecommunications system for services like voice calls, fax transmissions, electronic messaging, Internet browsing, etc.

It is well known in the field that because of the noticeably limited resources of pocket computers, in terms of physical size, display size, data processing power and input device, compared to laptop or desktop computers, user interface solutions known from laptop or desktop computers are generally not applicable or relevant for pocket computers. One example is controlling play functionality, e.g. fast forward play/rewind of a content using a point device.

In devices having touch-sensitive screen, a so-called “progress bar” is used to visually indicate the progress of a lengthy operation or brows a media. The progress bar may be one of three styles:
Segmented blocks that increase in steps from left to right.
A continuous bar that fills in from left to right.
A block that scrolls across a progress bar in a marquee fashion

Shortly, a progress bar is a component in a graphical user interface used to convey the progress of a task, such as a download or file transfer, audio or video play progress. The graphic may be accompanied by a textual representation of the progress in a percent format.

When a user watches or listens to a longer media file and wants to move to another location on the media, the progress bar may be used. In a touch-screen interface the user can often press the active progress-bar to initiate a function such as a replay time. The progress bar functions as a time line.

Most media players have a skip control with which the user can seta point where the playback can resume.

When the user watches a video, for example, he may wish to replay certain segments a number of times. As the video file is large and/or display is small one cannot interact with the skip controller with enough precision to pinpoint at what point in time to start or stop the replay, which may cause frustration. In sport events, for example, this function may be used to replay events of especial interest, e.g. scoring, penalty etc. The function may be used by the program producer or a user.

### SUMMARY

One object of the present invention is to provide means for controlling media with more accuracy and ability to fine tune playback initiation functionality of the media file.

For these and other reasons, a method of rescaling a time line corresponding to reproduction of a media on an electrical device, which comprises a touch sensitive screen is provided. In a first operative mode a time line control signal is generated during the reproduction of the media on the touch sensitive screen in a first scale. The method comprises setting a second mode by displacing a pointing means whereby, the displacement of the pointing means is responsive of changing of the time line scale. Preferably, the second mode is initiated by a user, media or automatically, The displacement is applied on an active area, which is configured as a progress bar and related to a media length and used to seta reset point. In one embodiment, the active area is a progress bar related to a media length and used to control media reproduction and the second scale is a time line resolution higher illustrated by change of a portion of the progress bar.

The invention also relates to a device comprising a touch sensitive screen, a first control unit for controlling the touch sensitive screen, and a second control unit for reproducing the media on the touch sensitive screen. The second control unit is configured to in a first operative mode a time line control signal is generated during the reproduction of the media on the touch sensitive screen in a first scale. The controller sets a second mode by displacing a pointing means whereby, the displacement of the pointing means is responsive of changing of the time line. The device may be one of a mobile terminal, telephone, a digital media player, a camera, a personal digital assistant (PDA), a computer or a device with content displaying and touch screen capability. The media is audio and/or video media. The device may comprise an active area on the touch sensitive screen and the displacement is applied on the active area, which is configured as a progress bar and related to a media length and used to set a reset point. The media may represent content accessed from an external device. The second mode may be initiated by a user, media or automatically. In one embodiment, the movement may be in a direction deviating from a plane of the touch sensitive screen.

### BRIEF DESCRIPTION OF THE DRAWINGS

Reference is made to the attached drawings, wherein elements having the same reference number designation may represent like elements throughout.

FIG. 1 is a diagram of an exemplary system in which methods and systems described herein may be implemented;

FIG. 2 illustrates a schematic view of a user interface according to one embodiment of the invention,

FIG. 3 is a flow diagram illustrating exemplary processing by the system of FIG. 1,

FIGS. 4a and 4b illustrate the operation of a user interface according to one embodiment of the present invention, and

FIG. 5 illustrates schematically a communication device according to one embodiment of the present invention.

### DETAILED DESCRIPTION

The following detailed description refers to the accompanying drawings. The same reference numbers in different drawings may identify the same or similar elements. The term “image,” as used herein, may refer to a digital or an analog representation of visual information (e.g., a picture, a video, a photograph, animations, etc).

The term “audio” as used herein, may include may refer to a digital or an analog representation of audio information (e.g., a recorded voice, a song, an audio book, etc).

Also, the following detailed description does not limit the invention. Instead, the scope of the invention is defined by the appended claims and equivalents.

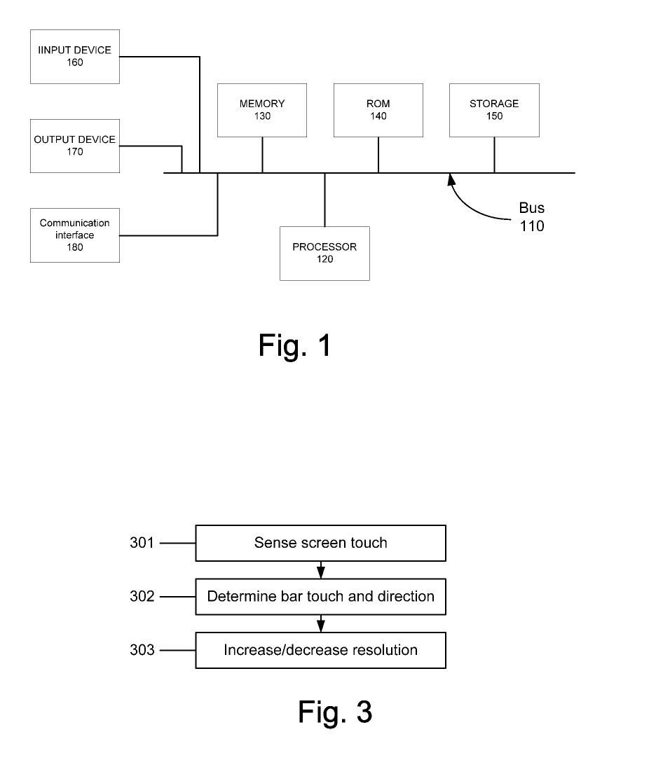

FIG. 1 is a diagram of an exemplary system 100 in which methods and systems described herein may be implemented. System 100 may include a bus 110, a processor 120, a memory 130, a read only memory (ROM) 140, a storage device 150, an input device 160, an output device 170, and a communication interface 180. Bus 110 permits communication among the components of system 100. System 100 may also include one or more power supplies (not shown). One skilled in the art would recognize that system 100 may be configured in a number of other ways and may include other or different elements.

Processor 120 may include any type of processor or microprocessor that interprets and executes instructions. Processor 120 may also include logic that is able to decode media files, such as audio files, video files, multimedia files, image files, video games, etc., and generate output to, for example, a speaker, a display, etc. Memory 130 may include a random access memory (RAM) or another dynamic storage device that stores information and instructions for execution by processor 120. Memory 130 may also be used to store temporary variables or other intermediate information during execution of instructions by processor 120.

ROM 140 may include a conventional ROM device and/or another static storage device that stores static information and instructions for processor 120. Storage device 150 may include a magnetic disk or optical disk and its corresponding drive and/or some other type of magnetic or optical recording medium and its corresponding drive for storing information and instructions. Storage device 150 may also include a flash memory (e.g., an electrically erasable programmable read only memory (EEPROM)) device for storing information and instructions.

Input device 160 may include one or more conventional mechanisms that permit a user to input information to the system 100, such as a keyboard, a keypad, a directional pad, a mouse, a pen, voice recognition, a touch-screen and/or biometric mechanisms, etc. Output device 170 may include one or more conventional mechanisms that output information to the user, including a display, a printer, one or more speakers, etc. Communication interface 180 may include any transceiver-like mechanism that enables system 100 to communicate with other devices and/or systems. For example, communication interface 180 may include a modern or an Ethernet interface to a LAN. Alternatively, or additionally, communication interface 180 may include other mechanisms for communicating via a network, such as a wireless network. For example, communication interface may include a radio frequency (RF) transmitter and receiver and one or more antennas for transmitting and receiving RF data.

System 100, consistent with the invention, provides a platform through which a user may play and/or view various media, such as music files, video files, image files, games, multimedia files, etc. System 100 may also display information associated with the media played and/or viewed by a user of system 100 in a graphical format, as described in detail below. According to an exemplary implementation, system 100 may perform various processes in response to processor 120 executing sequences of instructions contained in memory 130. Such instructions may be read into memory 130 from another computer-readable medium, such as storage device 150, or from a separate device via communication interface 180. It should be understood that a computer-readable medium may include one or more memory devices or carrier waves. Execution of the sequences of instructions contained in memory 130 causes processor 120 to perform the acts that will be described hereafter, in alternative embodiments, hard-wired circuitry may be used in place of or in combination with software instructions to implement aspects consistent with the invention. Thus, the invention is not limited to any specific combination of hardware circuitry and software.

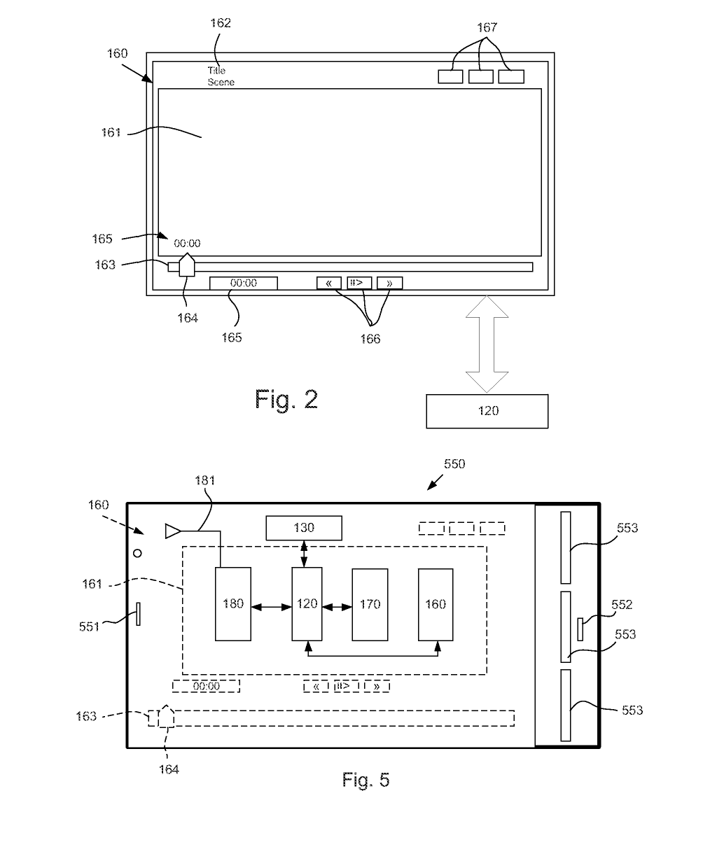

FIG. 2 illustrates a graphical touch-sensitive display 160. The display 160 is a general purpose display and may be programmed to display content of a display memory (not shown). The display according to this example is configured to show a video, and thus comprises a screen area 161 for reproducing the video. In an application for playing an audio content, the video area 161 may be used for displaying, for example a still image, or slide show.

Information about the content displayed (or played) may be displayed (continuously or temporary) in an information area 162, e.g. comprising title of the video and scene no. or any other relevant information. In case of audio media, e.g. name of artist, album, song etc. may be displayed.

The display further comprises a progress bar 163, which may be displayed continuously or temporary, e.g. when the screen is touched, in this case configured as an oblong slide bar in the base portion of the display 160. The bar may also be arranged in a side portion or the upper portion (also in mid-portion if not disturbing the content played) of the display. The bar 163 may be provided with a slidable knob 164 which may have several functions: e.g. show the progress of the media played and/or allow fast forward/rewind play of the media.

The field 165 may be connected to the knob 164 and move together with the knob in one or several directions. The screen field 165 may be dedicated for providing information about, for example the lapsed time, remaining time of the played media. Further control buttons 166 may be arranged to be displayed temporary or continuously for media play control, such as rewinds, play/pause and fast forward. The display may also include additional control buttons 167.

The display may be controlled with a driver circuit (not shown) or processor 120. All buttons and bars are programmed to be visualized on the display and the input in form of screen touch is input to the driver (or a special dedicated circuit) and the processor 120.

Thus, the display, using preprogrammed control buttons controls the media play. For example, if play/pause button 166 is touched a selected media starts playing (stopped or paused). Information about the media, such as title may be displayed in the information area 162. While the media is playing, a user may fast forward, rewind or mark the media for replay by means of the slidable knob 164.

According to the invention, a resolution increasing/deceasing function is introduced for increasing/decreasing progress bar resolution when setting a playback point or time. The resolution may be defined as t:x, wherein t is time and x is a progress bar length unit, e.g. one pixel of the progress bar may correspond to one minute. When a user puts a pointing means (e.g. finger or a pointing device, such as stylus) on the progress bar knob 164, the knob 164 can be moved in a horizontal direction (vertically) but if the user moves the pointing means, in this case, upwards or a direction other than horizontal, the area that the horizontal movement is mapped towards decreases, e.g. t:10x. The user may thus fine tune by moving the pointing means upwards (or other direction than horizontal). If the user moves the pointing means towards the bottom (or an opposite direction of the non horizontal direction) the progress bar resolution increases.

Of course, the horizontal and other directions mentioned above are given as examples and the directions depend on the position of the progress bar. If the progress bar is arranged on the side portion of the screen, the forward and rewind will be controlled by moving the knob up and down (vertical movement) and the fine tuning will be achieved by a non-vertical, e.g. horizontal, movement. The progress bar may be circular or have another shape.

Thus, according to the invention and with reference to FIG. 3, the processor receives 301 information from the touch-screen or driver that it is actuated. The positioning of the touched point is assumed to be well known to a skilled person and not described in here in more detail. If it is determined that the progress bar is touched the direction is determined 302 and based on the determined direction the speed resolution is set 303.

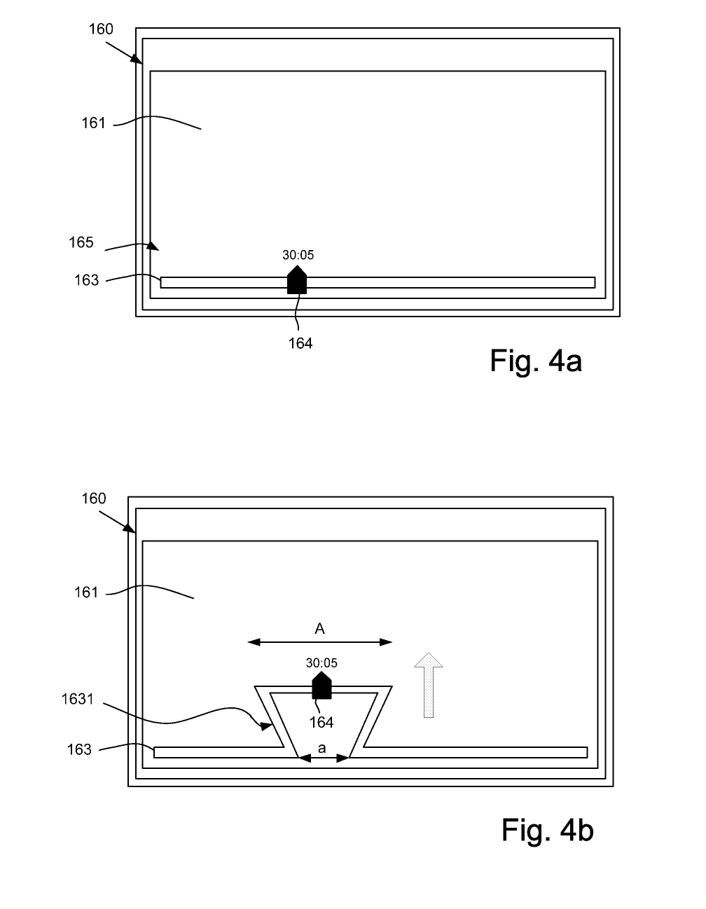

FIGS. 4a and 4b illustrate the simplified display of FIG. 2 in operation. In FIG. 4a, a media is started to play. The information area 165 shows the time lapsed, i.e. 30:05.

In FIG. 4b, the user has moved the pointing device in vertical direction, displacing the knob 164 in a distance. The progress bar 163 changes shape to indicate the time resolution change, e.g. through a “humpback” 1631. Clearly, the portion representing the resolution change may adopt other forms. The illustration of the progress bar change is not necessary for the function of the invention but convenient for the user. The distance A is high resolution corresponding to distance a, which may correspond to a time window, e.g. 10 minutes. When the user positions the pointing device on the progress bar, the time information may increases to indicate that by moving the pointing device the user will alter the resolution time factor. The device may be configured to have an altering or active mode, in which the non-horizontal movement is sensed and affects the media play. This mode may be started automatically or initiated by the user or may be media dependent. When the user stops influencing the bar, the progress bar may return to a passive mode. The active or passive modes may also be initiated by the user, e.g. by tapping on the screen or chosen in a property setting menu, etc.

The vertical movement to change the time resolution may be quantified such that an specific length unit corresponds to an specific time resolution.

In one embodiment, horizontal pinch gestures may be used to change the time scale. FIG. 5 illustrates a communication device 650 incorporating the present invention. The device comprises a processor 120, a memory 130, a read only memory (ROM) 140, a storage device 150, an input device 160, an output device 170, a communication interface 180 and an antenna 181. The function of varying parts has been described in conjunction with FIG. 1. The antenna 181 receives and transmits radio signals. The device future comprises ear peace/loudspeaker 551, microphone 552 and physical control keys 553.

The device 550 further comprises a graphical touch-sensitive display 160, comprising a screen area 161, an information area 162, a visual progress bar 163 provided with a slidable knob 164 and control buttons 167. The function of the display is described in conjunction with FIG. 2.

Further, while series of acts have been described with respect to FIG. 3, the order of the acts may be varied in other implementations consistent with the invention. Moreover, non-dependent acts may be performed in parallel.

It will also be apparent to one of ordinary skill in the art that aspects of the invention, as described above, may be implemented in any device/system capable of displaying a content using a touch sensitive screen.

The graphical representations provided to a user may represent content retrieved locally from system 100. In some implementations, the content may represent content accessed from an external device, such as a server accessible to system 100 via, for example, a network.

The invention may likewise be applied in devices having three dimensional sensing, whereby the rescaling may be achieved by moving the pointing means in one of x, y or z directions, i.e. the movement is in a direction deviating from the plane of the touch sensitive screen.

For example, in the implementation described above with respect to FIGS. 1-6, aspects of the invention may be implemented in a mobile terminal/telephone, such as a cellular telephone. In addition, aspects of the invention may be implemented in a digital media player, a camera, a personal digital assistant (PDA), a computer or any other device with content displaying and touch screen capability. Aspects of the invention may also be implemented in methods and/or computer program products. Accordingly, the invention may be embodied in hardware and/or in software (including firmware, resident software, micro-code, etc.). Furthermore, the invention may take the form of a computer program product on a computer-usable or computer-readable storage medium having computer-usable or computer-readable program code embodied in the medium for use by or in connection with an instruction execution system. The actual software code or specialized control hardware used to implement aspects consistent with the principles of the invention is not limiting of the invention. Thus, the operation and behavior of the aspects were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as a processor, a microprocessor, an application specific integrated circuit or a field programmable gate array, software, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

The scope of the invention is defined by the claims and their equivalents.

1. A method of rescaling a time line (163) corresponding to reproduction of a media on an electrical device (100), which comprises a touch sensitive screen (160), wherein in a first operative mode a time line control signal is generated during the reproduction of the media on said touch sensitive screen in a first scale, the method comprising:
setting a second mode by displacing a pointing means whereby, said displacement of said pointing means is responsive of changing of said time line scale.

2. The method of claim 1, wherein said second mode is initiated by a user, media or automatically.

3. The method of claim 1, wherein said displacement is applied on an active area, which is configured as a progress bar and related to a media length and used to set a reset point.

4. The method of claim 3, wherein said active area is a progress bar related to a media length and used to control media reproduction and the second scale is a time line resolution higher illustrated by change of a portion of said progress bar.

5. The method of claim 1, wherein said movement is in a direction deviating from a plane of said touch sensitive screen.

6. A device (100) comprising a touch sensitive screen (160), a first control unit (120) for controlling said touch sensitive screen, and a second control unit (120) for reproducing said media on said touch sensitive screen, characterised in that said second control unit is configured to, in a first operative mode, to generate a time line control signal during the reproduction of the media on said touch sensitive screen (160) in a first scale, the second controller is configured to set a second mode when a pointing means is displaced, whereby said displacement of said pointing means is responsive of altering said time line scale.

7. The device of claim 6, being one of a mobile terminal, telephone, a digital media player, a camera, a personal digital assistant (PDA), a computer or a device with content displaying and touch screen capability.

8. The device of claim 6, wherein said media is audio and/or video media.

9. The device of claim 6, comprising an active area on said touch sensitive screen and said displacement is applied on said active area, which is configured as a progress bar and related to a media length and used to set a reset point.

10. The device of claim 6, wherein said media represents content accessed from an external device.

11. The device of claim 6, wherein said second mode is initiated by a user, media or automatically.
